(19) United States
(12) Patent Application Publication
(10) Pub. No.: US 2017/0235727 A1
(43) Pub. Date: Aug. 17, 2017

(54) Electronic Filing System for Electronic Document and Electronic File

(71) Applicant: Kim Seng Kee, Kuala Lumpur (MY)

(72) Inventors: Kim Seng Kee, Kuala Lumpur (MY); Keong Hway Chhua, Kuala Lumpur (MY)

(21) Appl. No.: 15/519,124

(22) PCT Filed: Oct. 13, 2015
(86) PCT No.: PCT/MY2015/050129

§ 371 Date: Apr. 13, 2017

(30) Foreign Application Priority Data
Oct. 13, 2014 (MY) PI2014703019

(51) Int. Cl. G06F 17/30; G06F 17/24

(52) U.S. Cl. CPC G06F 17/30011; G06F 17/30126; G06F 17/30917; G06F 17/30557; G06F 17/30595; G06F 17/24

(57) ABSTRACT

The present invention relates to a system to emulate manual filing system by storing and processing document that operates on Relational Database Management System (RDBMS), comprising; a Electronic Document (eDoc) (11) having at least one Electronic Document Identifier (eDoc-Identifier), Section, Rowtype and Column; a Virtual Memory for storing the Electronic Document (eDoc) (11); and a Web-Read Module (4) for retrieving the Electronic Document (eDoc) (11) from the Virtual Memory based on at least one identifier of Electronic Document (eDoc) (11).

### FIELD OF INVENTION

The proposed invention relates to a system and method to emulate manual filing system by storing and processing document that operates on Relational Database Management System (RDBMS).

### BACKGROUND ART

An age of integration—in which data, images, audio and video are used together, often in the same document or process—has generated a real need for an efficient, seamless and intuitive means of storing and retrieving all this digital information. This usually means having to manage complex relationships between stored entities. Traditional methods involve breaking up and placing parts of the data into various tables so that a relational database management system (RDBMS) can handle them: this highly complex task involves designing and managing relationships between data items stored in the various tables.

Software development for enterprise is complex and time consuming as it may require hundreds of man years. The main contributor to complexity is the tens of thousands of tables necessary in an enterprise system. The design of the database together with the primary and foreign keys complicates SDLC. Also tables require extra programs to link and split documents.

The legacy system that uses RDBMS as its database cannot store documents and folios, the documents and folios must be split into tables with different primary keys and foreign keys to be able to store onto RDBMS. The thousands of table designs must include all input tables, intermediate tables and output tables is a very complicated undertaking.

The thousands of tables complicate systems development life cycle (SDLC) & complicates data managements. Therefore, to provide a one view of customer folio, general ledger folio, stock folio, etc. is a difficult effort as the data must be transformed between each process (web, transmission, storage, processing (batch, on-line, BPM), data-warehousing, data-mining, output.

In Legacy system, it is difficult to integrate data & system because it is usually developed by different group as Legacy systems involve thousands of tables. The Documents, Flows, Business Rules & Codes are often lost in the process, therefore difficult for business personnel to talk to the computer people.

Because of the complexity, software changes are slow, complex & expensive, the dateline are difficult to meet. What is really needed is an efficient system which stores structured, semi-structured and unstructured data (and the schema which describes the data), and manages the relationships between data items.

Therefore an invention is proposed a system to emulate manual filing system by storing and processing electronic document that operates on Relational Database Management System (RDBMS).

### SUMMARY OF INVENTION

The present invention provides a system to emulate manual filing system by storing and processing document that operates on Relational Database Management System (RDBMS), comprising; a Electronic Document (eDoc) having at least one Electronic Document Identifier (eDoc-Identifier), Section, Rowtype and Column; a Virtual Memory for storing the Electronic Document (eDoc); and a Web-Read Module for retrieving the Electronic Document (eDoc) from the Virtual Memory based on at least one identifier of Electronic Document (eDoc).

A further aspect of the present invention provides a system to emulate manual filing system by storing and processing document that operates on Relational Database Management System (RDBMS), wherein the Web-Read Module for retrieving the Electronic Document (eDoc), further comprising; a Paging Module having the Electronic Document (eDoc) append into at least one Electronic File (eFile) in the RDBMS according to a predefined Page limit; a Index Module having at least one Index for the Electronic File (eFile) based-on document identifier, date, end sequence number, document status, document offset and document length; and a Read Module to obtain the Index and at least one Data Relative Page of the Electronic File (eFile) from the Index Module based on the identifier, in which the Electronic Document (eDoc) retrieved from the Paging Module based on the retrieved Index and Data Relative Page to be stored in the Virtual Memory and update the Index Module.

Preferably, the identifier of Electronic Document (eDoc) comprising the Electronic Document Identifier (eDoc-Identifier), Section, Rowtype and Column.

Preferably, the identifier of Electronic Document (eDoc) comprising document identifier, date, end sequence number, document status, document offset and document length.

Another aspect of the present invention provides a system to emulate manual filing system by storing and processing document that operates on Relational Database Management System (RDBMS), comprising; a Enquiry Module for retrieving a pluralities of Electronic Document (eDoc) information based on at least one Information for the Electronic Document Identifier (eDoc-Identifier), Section, Rowtype and Column of Electronic Document (eDoc), in which the retrieved Electronic Document (eDoc) information having at least one file history display into at least one list form.

Preferably, the list form having at least one predefined information for each document.

Further, the Enquiry Module, further comprising a Editing Module to load the retrieved Electronic Document (eDoc) for updating the retrieved Electronic Document (eDoc) and store at least one Updated Data to the Virtual Memory.

Further, the Enquiry Module, further comprising a Viewing Module to load the retrieved Electronic Document (eDoc) for viewing the retrieved Electronic Document (eDoc).

Further, the Enquiry Module further includes a Searching Module, wherein the Searching Module retrieves the Electronic Document (eDoc) using the Web-Read Module based-on at least one Index, in which the index is retrieved from the identifier of Electronic Document (eDoc) comprising document identifier, date, end sequence number, document status, document offset and document length.

Another aspect of the present invention provides a system to emulate manual filing system by storing and processing document that operates on Relational Database Management System (RDBMS), comprising; a Uploading Module to upload the Electronic Document (eDoc) based the identifier of Electronic Document (eDoc), in which the Uploading Module establish connection to at least one server having RDBMS and update the RDBMS with the uploaded Electronic Document (eDoc).

The present invention also provides a method to emulate manual filing system by storing and processing document that operates on Relational Database Management System (RDBMS), comprising steps of; obtaining at least one identifier of Electronic Document (eDoc); validating if there is at least one Electronic Document (eDoc) based on the identifier in at least one Virtual Memory using a Web-Read Module; and retrieving the validated Electronic Document (eDoc) from the Virtual Memory, If there is Electronic Document (eDoc) in the Virtual Memory;

Another aspect of the present invention provides a method for validating if there is at least one Electronic Document (eDoc) based on the identifier in at least one Virtual Memory using a Web-Read Module, further comprising steps of; obtaining at least one Index and at least one Data Relative Page of a Electronic File (eFile) having document identifier, date, end sequence number, document status, document offset and document length from a Index Module based on the identifier; retrieving the Electronic Document (eDoc) from a Paging Module based on the Index and Data Relative Page in the RDBMS; storing the Electronic Document (eDoc) in the Virtual Memory; and updating the Index Module.

Preferably, identifier of Electronic Document (eDoc) comprising the Electronic Document Identifier (eDoc-Identifier), Section, Rowtype and Column.

Preferably, the identifier of Electronic Document (eDoc) comprising document identifier, date, end sequence number, document status, document offset and document length.

Another aspect of the present invention provides a method to emulate manual filing system by storing and processing document that operates on Relational Database Management System (RDBMS), comprising steps of; retrieving a pluralities of Electronic Document (eDoc) information based on at least one Information for the Electronic Document Identifier (eDoc-Identifier), Section, Rowtype and Column of Electronic Document (eDoc) using a Enquiry Module; and displaying the retrieved Electronic Document (eDoc) information having at least one file history into at least one list form.

Preferably, the list form having at least one predefined information for each document.

Preferably, the retrieving a pluralities of Electronic Document (eDoc) information using Enquiry Module, further comprising steps of loading the retrieved Electronic Document (eDoc) for updating the retrieved Electronic Document (eDoc) and store at least one Updated Data to the Virtual Memory using a Editing Module.

Preferably, the retrieving a pluralities of Electronic Document (eDoc) information using Enquiry Module, further comprising steps of loading the retrieved Electronic Document (eDoc) for viewing the retrieved Electronic Document (eDoc) using a Viewing Module

Preferably, the retrieving a pluralities of Electronic Document (eDoc) information using Enquiry Module, further comprising steps of retriving the Electronic Document (eDoc) using the Web-Read Module based-on at least one Index, in which the index is retrieved from the identifier of Electronic Document (eDoc) comprising document identifier, date, end sequence number, document status, document offset and document length using a Searching Module.

Preferably, the Electronic Document (eDoc) stored in the Virtual Memory, further comprising steps of; uploading the Electronic Document (eDoc) based the identifier of Electronic Document (eDoc) from the Virtual Memory; establishing connection to at least one server having RDBMS; and updating the RDBMS with the uploaded Electronic Document (eDoc).

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF PREFERRED EMBODIMENT

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

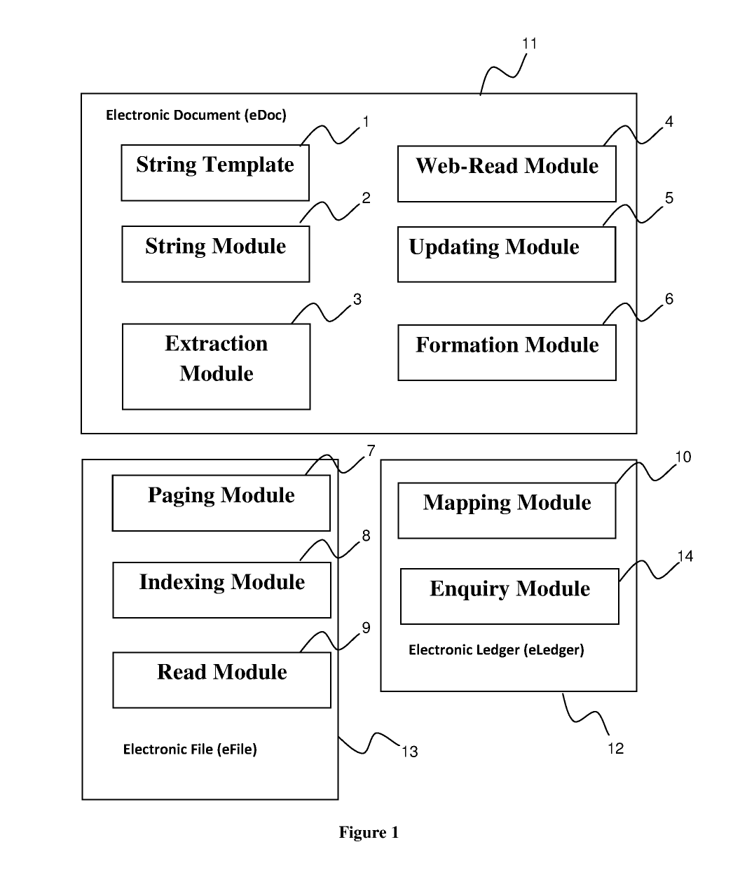

FIG. 1 illustrates overall architecture of the Electronic Document (eDoc) and Electronic File (eFile).

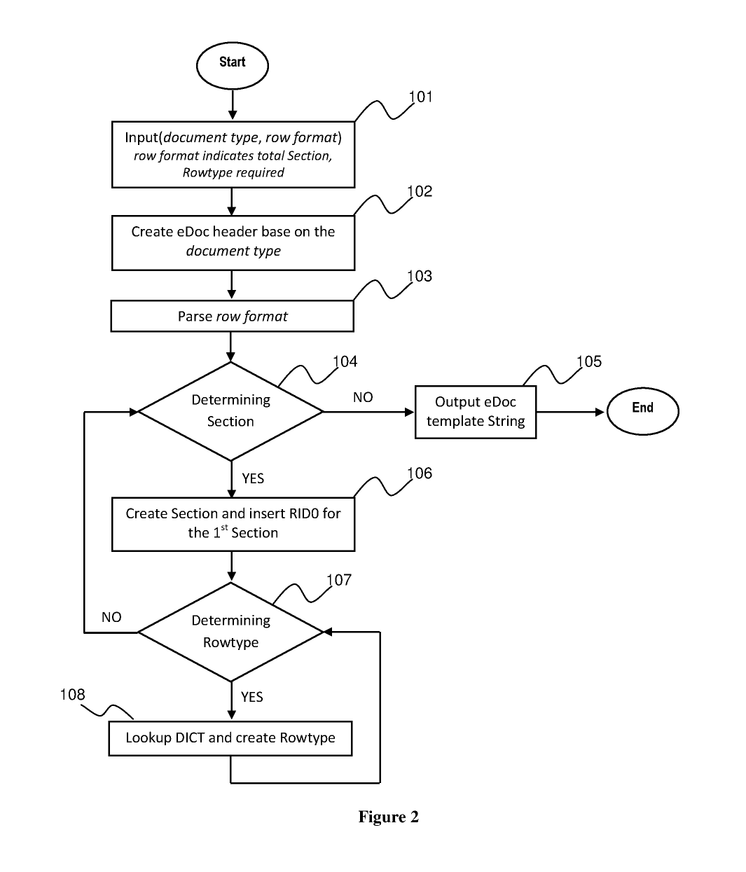

FIG. 2 illustrates a flow chart for creating a Electronic Document (eDoc) template string.

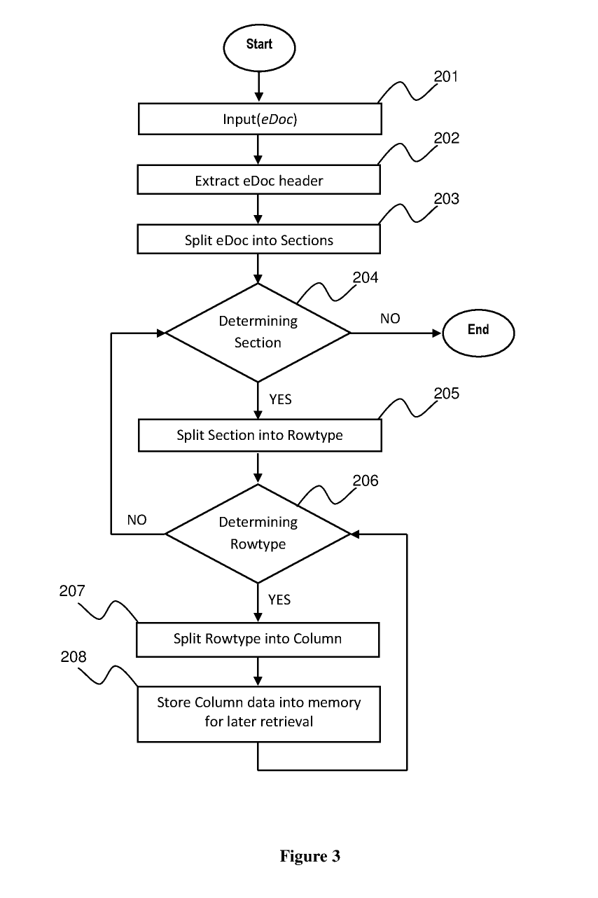

FIG. 3 illustrates a flow chart of extracting process from a Electronic Document (eDoc) String.

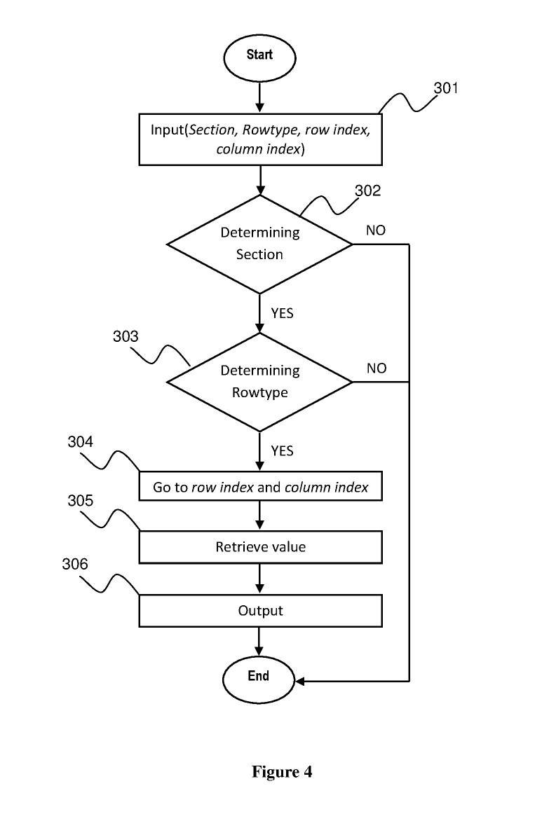

FIG. 4 illustrates a flow chart of retrieving process for data from the Column of extracted Electronic Document (eDoc).

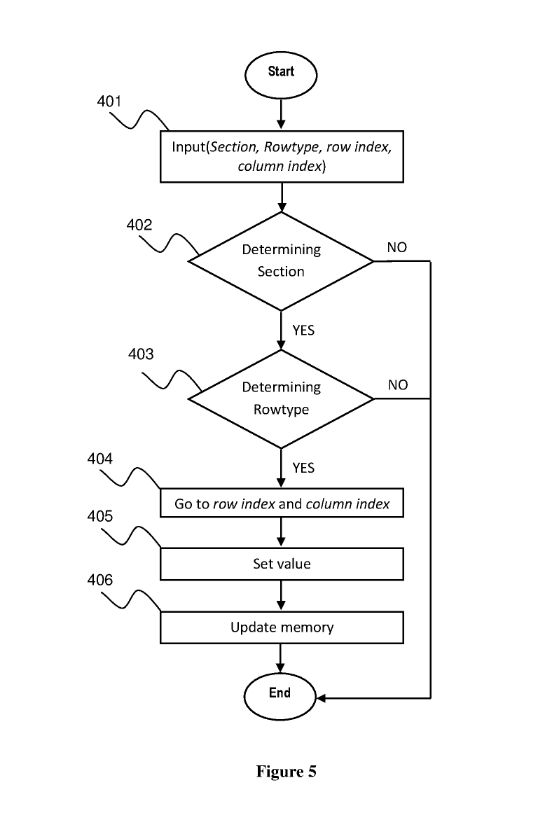

FIG. 5 illustrates a flow chart of updating process for data from the retrieved row index and column index.

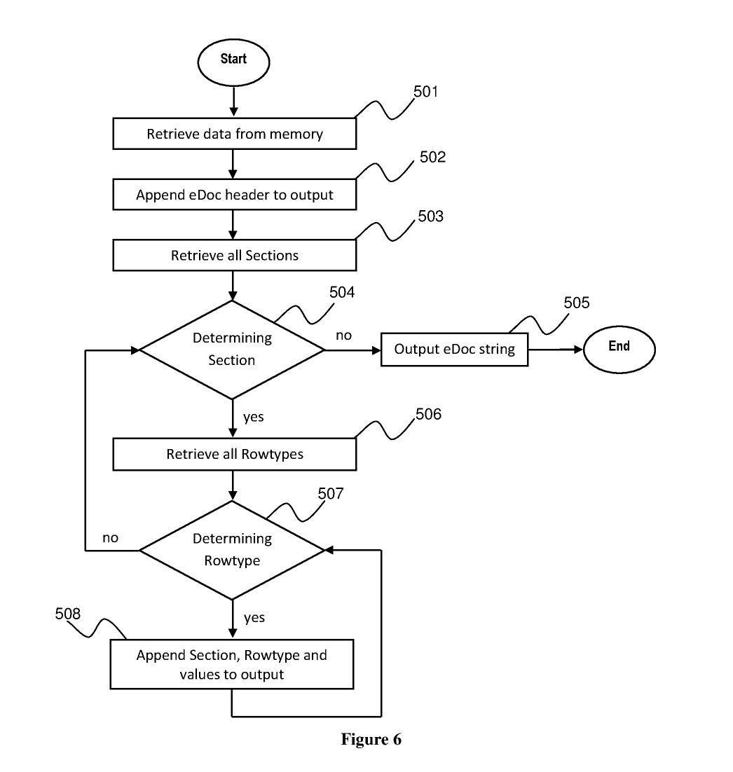

FIG. 6 illustrates a flow chart of uploading process for a Electronic Document (eDoc) String.

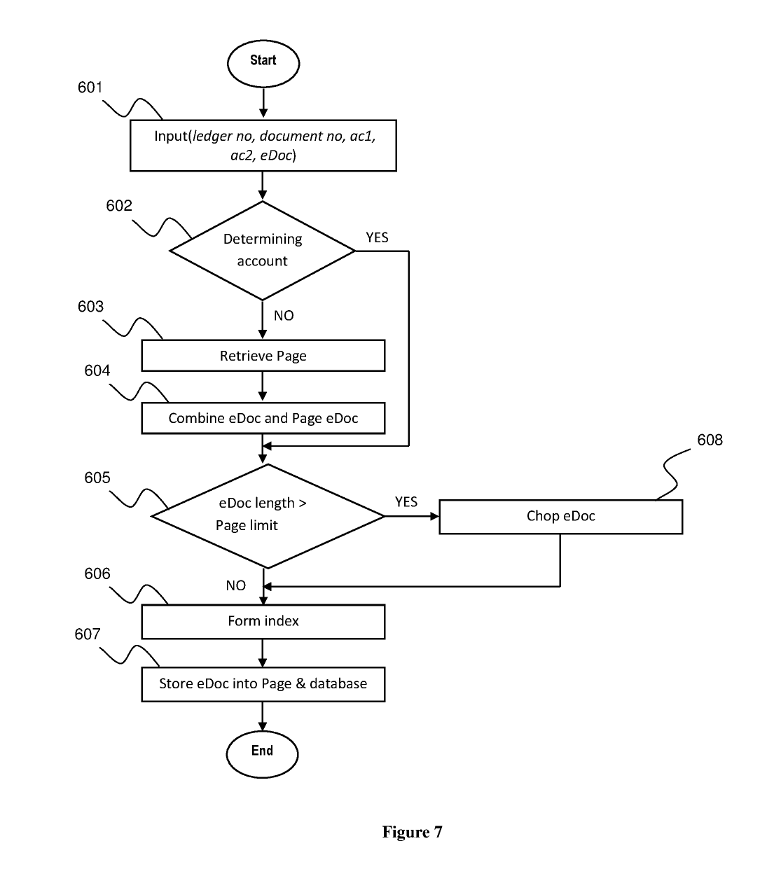

FIG. 7 illustrates a flow chart of paging process of a Electronic Document (eDoc) for a Electronic File (eFile).

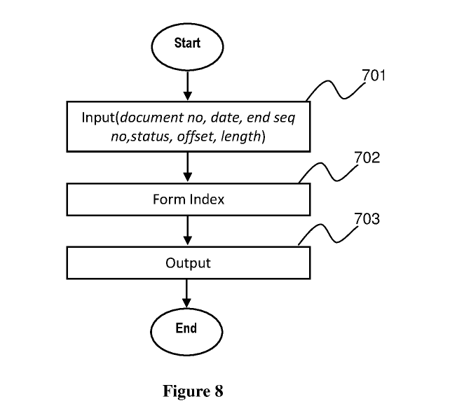

FIG. 8 illustrates a flow chart of indexing process of a Electronic Document (eDoc) for a Electronic File (eFile).

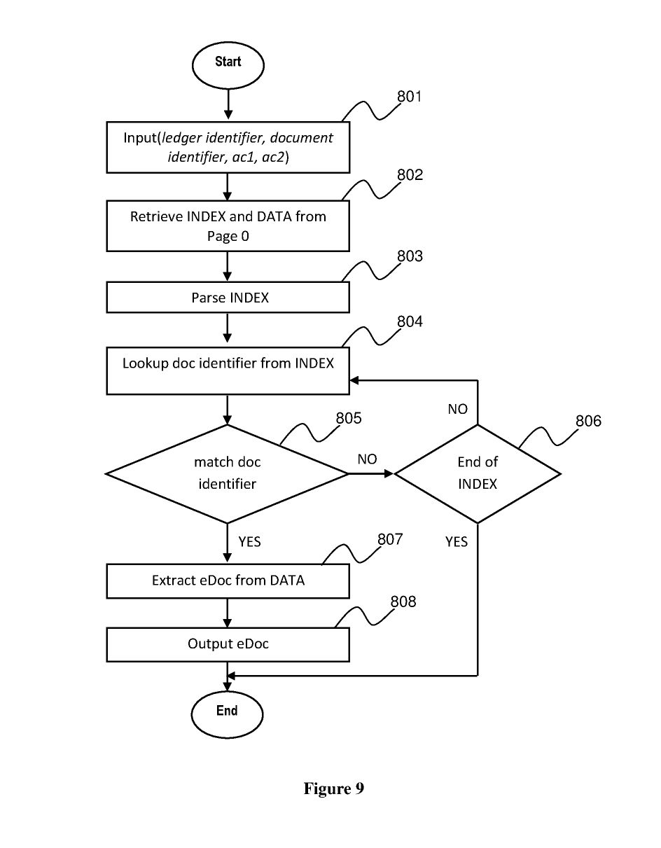

FIG. 9 illustrates a flow chart of reading process of a Electronic Document (eDoc) for a Electronic File (eFile).

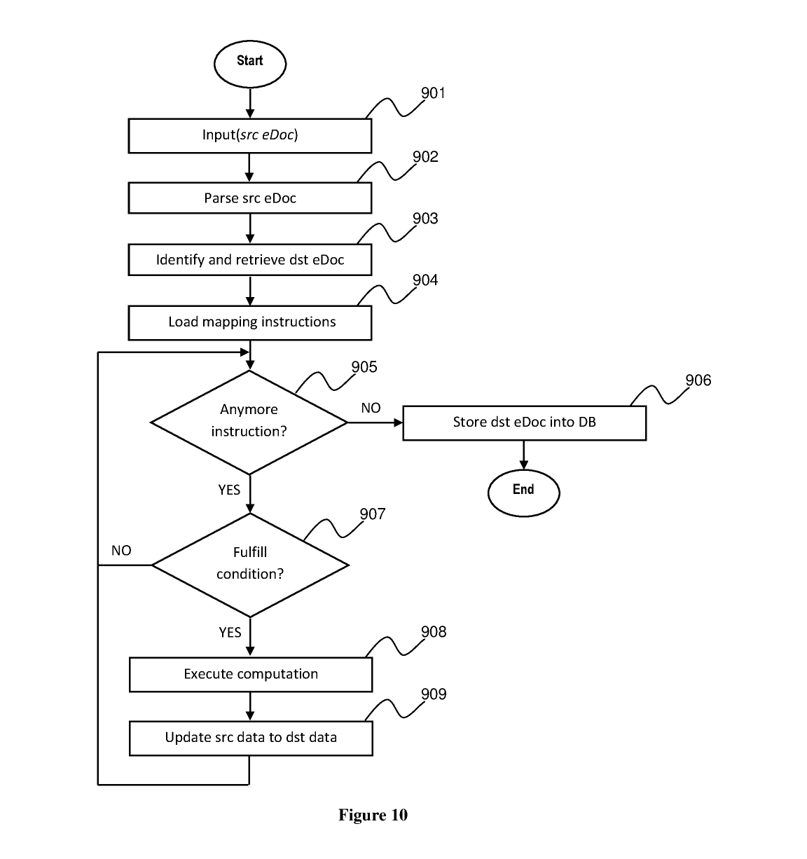

FIG. 10 illustrates a flow chart of Mapping process of a Electronic Document (eDoc) for a Electronic File (eFile).

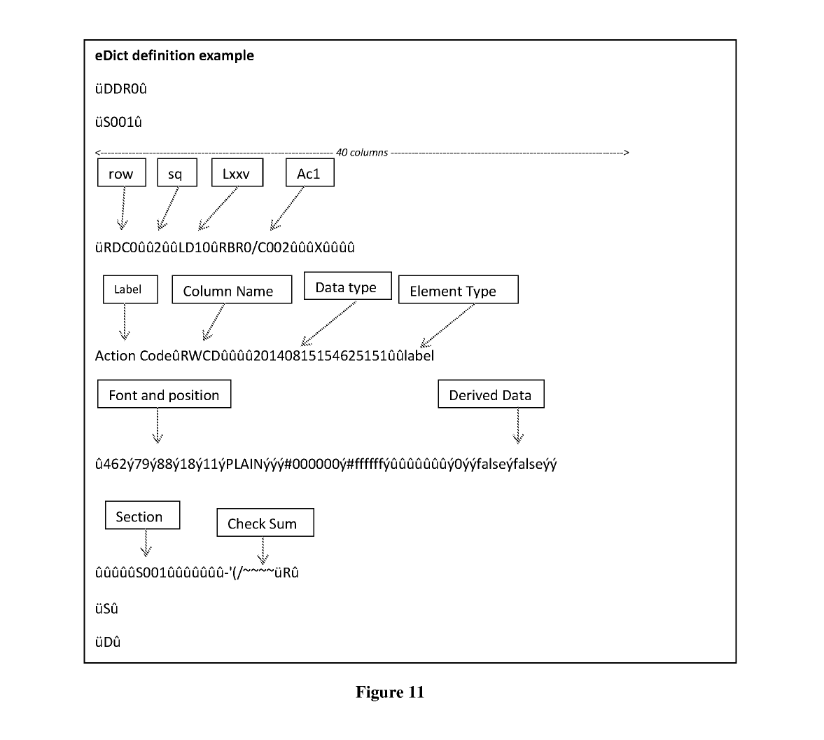

FIG. 11 illustrates an example of Electronic Dictionary (eDict) or metadata is used to describe the attribute/behavior in a string.

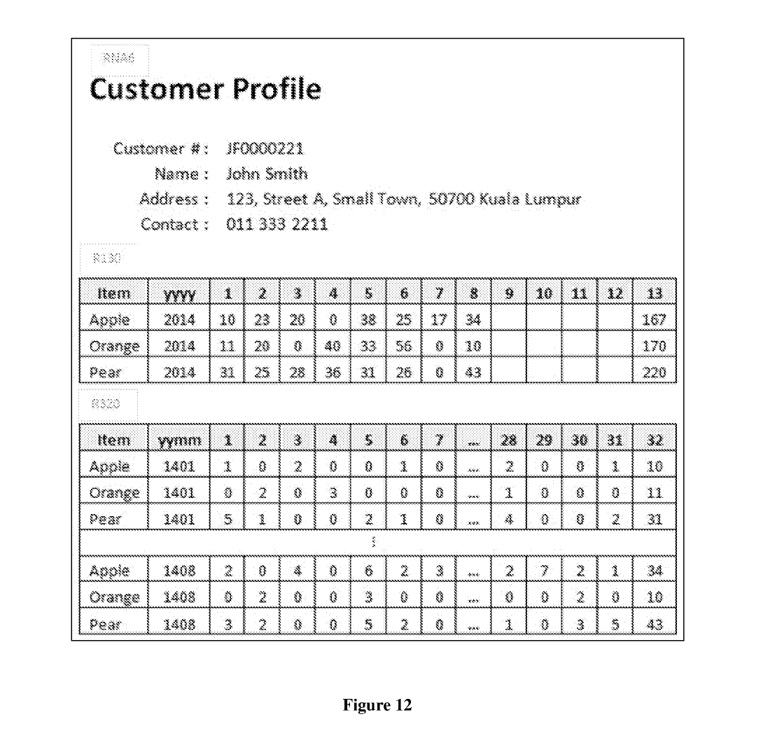

FIG. 12 illustrates an example eLedger containing details of a customer profile and item details.

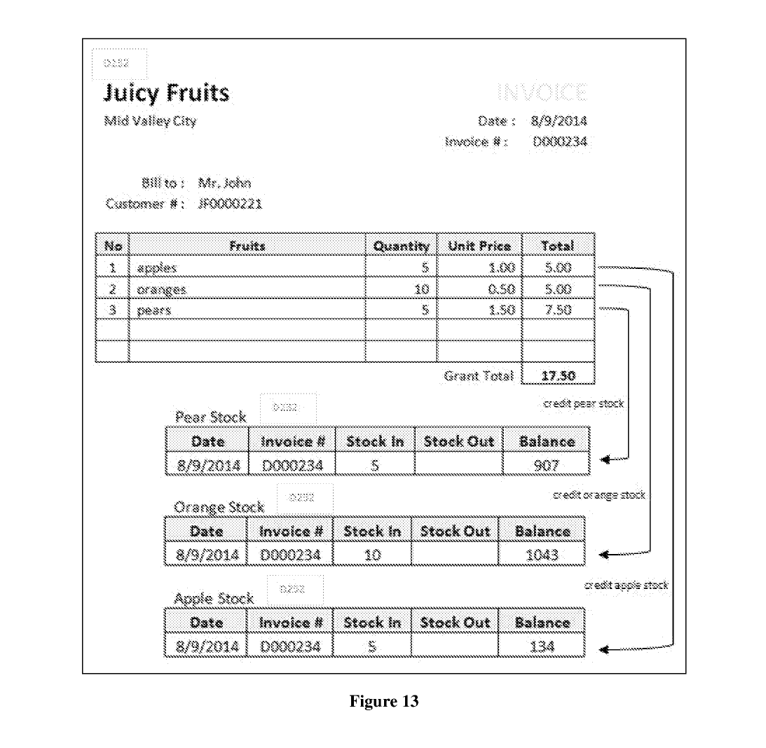

FIG. 13 illustrates an example creation of subDoc based on the example as in FIG. 12.

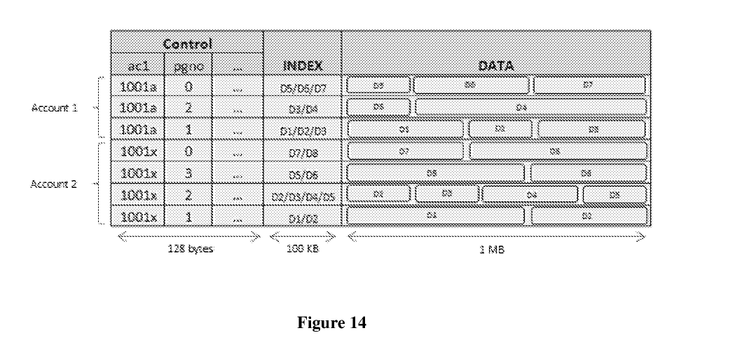

FIG. 14 illustrates an example of how eFiles store in a RDBMS Table.

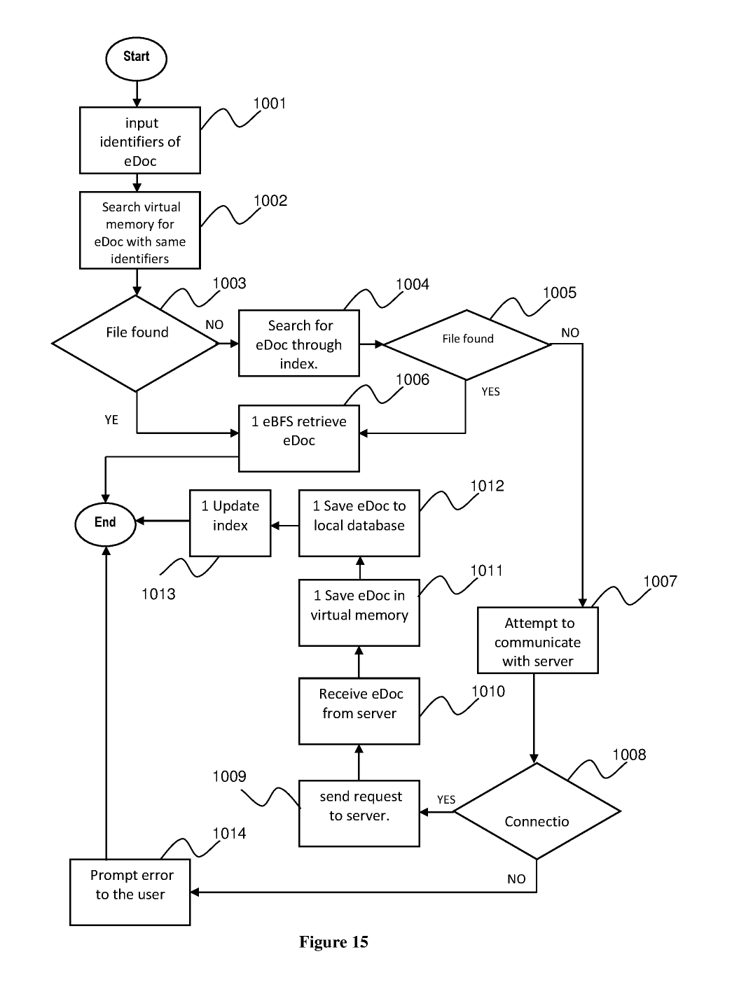

FIG. 15 illustrates a flow chart of Retrieving process for retrieving Electronic Documents (eDocs) based on request using Electronic Browser Filing System (eBFS).

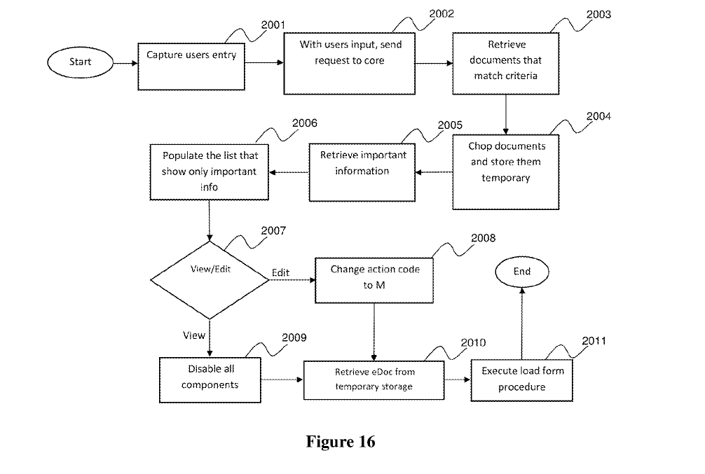

FIG. 16 illustrates a flow chart of Enquiry process for retrieving and listing Electronic Documents (eDocs) based on request using Electronic Browser Filing System (eBFS).

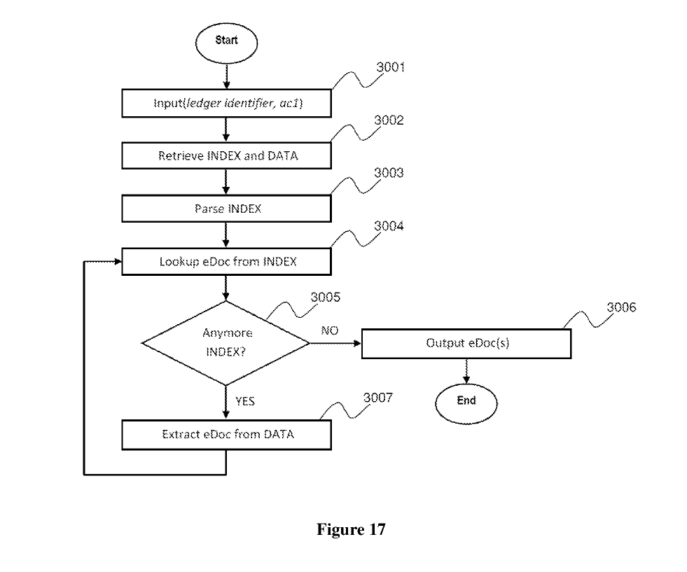

FIG. 17 illustrates a flow chart for Searching a Electronic Document (eDoc) using Electronic Browser Filing System (eBFS).

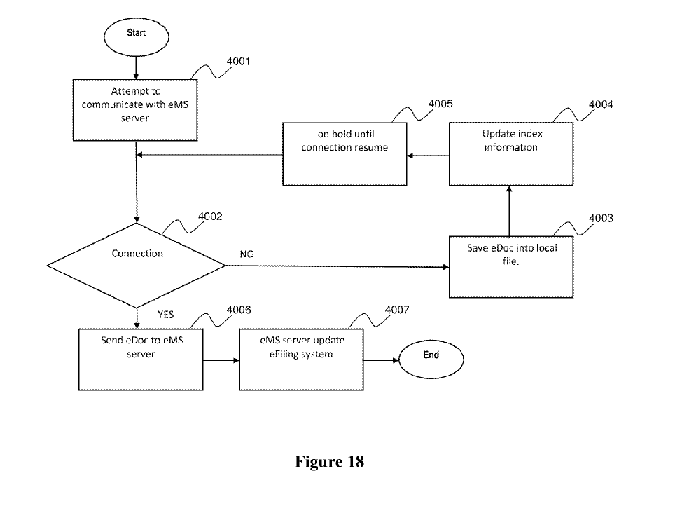

FIG. 18 illustrates a flow chart for Uploading a Electronic Document (eDoc) using Electronic Browser Filing System (eBFS).

### DETAILED DESCRIPTION OF THE PREFERRED EMBODIMENTS

The proposed invention relates to a system and method to emulate manual filing system by storing and processing document that operates on Relational Database Management System (RDBMS).

Data is stored in a format called Electronic Document (eDoc), which serves as the display, storage, processing, and transmission format throughout the systems development life cycle, without transformation at any stage. Data can be imported from or exported to any format including PDF, XML, XLS and CSV.

An Electronic File (eFile) stores eDocs (with all data file types) on a database (RDBMS). Filing System predominantly utilizes the database read, write and index functions only. Therefore it can utilise almost all popular RDBMS, and if necessary can handle any customised, in-house database systems.

As illustrated in FIG. 1, the system to emulate manual filing system for storing and processing document that operates on Relational Database Management System (RDBMS), comprising; a String Template (1) having at least one details of document number, number of sections and number of rows defined based on at least one Input; a String Module (2) for generate a Electronic Document (eDoc) (11) having at least one Electronic Document Identifier (eDoc-Identifier), Section, Rowtype and Column by validating the document number, number of sections and number of rows based on the String Template (1); and a Extraction Module (3) for extracting the Electronic Document Identifier (eDoc-Identifier), Section, Rowtype and Column of Electronic Document (eDoc) (11) generated by the String Module (2) for retrieval process. The system also includes a Retrieval Module (4) for retrieving at least one Retrieved Data from the data of Electronic Document (eDoc) (11) stored in the database based on at least one Input of the Section, Rowtype and Column; a Updating Module (5) for updating the Retrieved Data of Electronic Document (eDoc) (11) and store at least one Updated Data to the database based on the Input of Section, Rowtype and Column defined; and a Formation Module (6) for forming the updated Electronic Document (eDoc) (11) by retrieving the Updated Data based on the Input of Section, Rowtype and Column. Further, the system has a Paging Module (7) for append Electronic Document (eDoc) (11) in the database into at least one Electronic File (eFile) (13) according to a predefined Page limit; a Indexing Module (8) for forming at least one Index to the Electronic File (eFile) (13) based-on document identifier, date, end sequence number, document status, document offset and document length; and a Read Module (9) for retrieving the Index and at least one Data Relative Page (Page 0) of the Electronic File (eFile) (13) based on at least one Read Input to at least one Output. In addition the system further includes a Mapping Module (10) for updating at least one Retrieved Data based on at least one Mapping Input by determining the Electronic File (eFile) (13) using the Read Module (9) to retrieve the Retrieved Data of Electronic Document (eDoc) (11) using the Retrieval

Module (4), in which the Updating Module (5) update the Retrieved Data to the database and forming the Retrieved Data into the Electronic Document (eDoc) (11) using the Formation Module (6) for updating into at least one Electronic File (eFile) (13) using Paging Module (7) and forming at least one Index using the Indexing Module (8); and a Enquiry Module (14) for retrieving a pluralities of Electronic Document (eDoc) (11) information using a Read Module (9) based on at least one Information for the Electronic Document Identifier (eDoc-Identifier), Section, Rowtype and Column of Electronic Document (eDoc) (11), in which the retrieved Electronic Document (eDoc) (11) information having at least one file history display into at least one list form.

As illustrated in FIG. 2, the system or module are initiated by creating a template by defining a new document and indicate number of sections and number of rows required, which will be defined by an input from a user or a database (101). Then, the system or module creates a Electronic Document (eDoc) based on the document number defined from the input (102). Thereafter, the system or module interprets the eDoc Identifier for further processing, where the system or module validates how many sections or Rowtype defined in the input to form a eDoc template string (103). If there is section defined in the input, the system or module will create a new section and define or classify (label) the section if it is the 1^{st} Section in the input (106). Then the system or module validates is there any Rowtype defined in the input (107). If there is Rowtype defined in the input, the system or module will create a new Rowtype based on a Predefined Dictionary (108). The system or module further will validates if there is any other Section or Rowtype defined in the input for further processing (104, 107). If there no other Section or Rowtype defined in the input, the system or module will further process to generate the eDoc template string with a document number (105).

As illustrated in FIG. 3, the system or module are initiated by retrieving a Electronic Document (eDoc) String for extraction process (201), where the system extract a eDoc Identifier from the eDoc String having a document number (202). Then, the system will determine the section of the eDoc Identifier predefined in the eDoc String (203). If there is section defined in the eDoc Identifier (204), the system will split the section into Rowtype for further processing (205). Then, the Rowtype will split into column of data (207), where the column of data will be stored into a Database (208). The system further will validates if there is any other Section or Rowtype defined in the input for further processing (204, 206). If there no other Section or Rowtype defined in the input, the system will further process for retrieval of data in the Column.

As illustrated in FIG. 4, the system or module are initiated by receiving input from a database or a user (301). Then, the system validates the Section and Rowtype based on the receiving input for retrieval process (302, 303). If valid section is determined, the system validates the Rowtype. If the valid Rowtype is determined, the system will locate the row index and column index (304). Then, the data is retrieved from the located row index and column index (305) and outputs the results for further processing (306).

As illustrated in FIG. 5, the system or module are initiated by receiving input from a database or a user (401). Then, the system validates the Section and Rowtype based on the receiving input for updating process (402, 403). If valid section is determined, the system validates the Rowtype. If the valid Rowtype is determined, the system will locate the row index and column index (404). Then, the data is updated to the located row index and column index based on the input received (405). Then, the updated data will be stored into a Database (406).

As illustrated in FIG. 6, the system or module are initiated by retrieving the updated data stored in a Database for uploading process (501), where the system append the Electronic Document (eDoc) to output (502). Then, the systems will determine the number of section from the updated data stored in a Database to be assembled. If there is section defined in updated data, the systems will retrieve all the section from the updated data stored in a Database (503). Then, the system will retrieve all Rowtype for further processing (506). The system further will validates if there is any other Section or Rowtype defined in the updated data stored for further processing (504, 507). If there no other Section or Rowtype defined in the input, the system will further proceed to append the retrieved Section, Rowtype and values (508) to be uploaded into a eDoc String (505).

As illustrated in FIG. 7, the system or module are initiated by receiving input from a database or a user, in which it contains information such as: ledger identifier, document identifier, account 1 and account 2 and eDoc (601). Then, the system validates with the database if this account is a new account (602). If it's not a new account, the system retrieves the existing Page from the database for later processing (603) and append eDoc form input to the eDoc from Page (604). However, if it's a new account, the system validate if the length of the combined eDoc is greater than the Page limit (605). If the length of the combined eDoc is greater than Page Limit, the system chops the combined eDoc into desired Pages according to predefined Page limit (608). Otherwise, each Index will be formed based-on document identifier, date, end sequence number, document status, document offset and document length (606). Then, store Page and Index into database (607).

As illustrated in FIG. 8, the system or module are initiated by receiving input from a database or a user, in which it contains information such as: document identifier, date, end sequence no, document status, document offset and document length (701). Then, forming an Index by combining all input as a string and each input is separated by colon (:) (702) and return the formed Index to the system that triggered this operation (703).

As illustrated in FIG. 9, the system or module are initiated by receiving input from a database or a user, in which it contains information such as: ledger identifier, document identifier, account 1 and account 2 (801). Then, the system retrieves Index (indexes) and DATA of Relative Page for a given or specified account from a eFile stored in the database (802). Thereafter, parse the Index into individual index for processing (803). Then, the system retrieves a index that contains document identifier or information from the input received (804). Then, the system validates if there matching indexes from the input received (805). If found, the system will extract the offset and the length of the target eDoc (806) and the system further extract the eDoc from DATA of Relative Page (807). Then, output the extracted eDoc to the database or user requested (808).

As illustrated in FIG. 10, the system or module are initiated by receiving input from a database or a user, such as source or details of eDoc (901).

Then, parse source eDoc for further processing (902). Then, identify and load destination eDoc (for later updating) (903). Then, loading predetermined mapping instructions (904). Then, the system validate if the data of the predetermined source column fulfill the predetermined requirement (907), if there are more mapping instruction. Then, perform computation on the data of the predetermined source column if there is one more mapping instruction (908). However, if there are no further mapping instruction, the system store the updated destination eDoc back into database (906). Thereafter, the system will sum up the result from the computation with the data of the predetermined destination column and update the final result to the predetermine destination column (909). This process will be carried on till there is no more mapping instruction (905) and store the updated destination eDoc back into database (906).

eDoc Filing System account-centric system that acts as a display, transmission, storage and processing medium from end to end without requiring any other transformation or normalization.

Electronic File (eFile) is an electronic folio (similar to a file in conventional manual filing systems) where all types of documents with different data types can be stored together in an account-centric manner.

The Filing system logically stores all data and information that relate to a single account in an Electronic File (eFile), in chronological order. The Electronic Document (eDoc) are stored as sequential strings of data mapped to a data dictionary, and may include multiple data types in each string (e.g. image files, binary files, comma separated format, XML or any of the nearly 500 data formats in existence today). This allows the storage of any type of data within one record. The way eDoc stores its data provides near real-time data mining without the need for data modeling.

eDoc is a data storage format comprising strings containing multiple rows each preceded by a unique row code: RxxV-Rxx being the row# and V the version#. Multiple rows of data of various rows make an eDoc. All data is stored in variable length or fixed length columns. Each row contains multiple columns separated by terminators. There are special terminators for start and end of DxxV (documents), RxxV (rows), etc. eDoc is designed for change. Various versions of RxxV and DxxV can exist concurrently. eDoc can be converted to XML and vice versa. eDoc is similar to XML as its data also has separators and identifiers and tags, but eDoc has additional system fields that provide new functionality. If required, XML is used as a universal transmission document and passed to other systems, where data can be normalized to tables. The table 1.0 and 2.0 further describes the terminators (separator) and identifiers and tags.

eDoc String
Example of eDoc String -Data Structure: (Store in LxxV)

```
üDxxVû
      üSxxVû
            üRID0ûûûûûûûûûûûûûûûûûûûûûûûüRû
            üRxxVûûû... ûûûüRû
            ...
            üRxxVûûû... ûûûüRû
      üSû
      ...
      üSxxVû
      ...
      üSû
üDû
```

### Terminators (Separator) Coding Structure

TABLE 1.0
Basic Separator

| Code | Separator | Example |
|---|---|---|
| üDxxVû | Start Document | üDJS4û- start of Job sheet |
| üDû | End Document | üDû |
| üSxxVû | Start Section | üS001û- start of 1^{st} Section |
| üSû | End Section | üSû |
| üRxxVû | Start Row | üRNA1û- start of Name/Address Row v1 |
| üRû | End Row | üRû |
| u | Field Separator | ûfield-1û . . . ufield-n |
| y | SubField | ý sub field-1 ý . . . ý subfield-n |
| | Separator | |
| ü[ | Open Packet | ü[üDJS1 . . . open packet for subDoc of |
| | | DJS1 |
| û] | Close Packet | . . . üSûüDûü]close packet for the subDoc |

### LDSRC Coding Structure

TABLE 2.0

| Code | Description | Example |
|---|---|---|
| LxxV | Ledger Code | LJS4: Jobsheet Ledger version 4 |
| DxxV | Document Code | DJS4: Jobsheet Document version 4 |
| SxxV | Section Code | S001: Section 1 |
| RxxV | Row Code | RNA5: Name Address Rowtype version 5 |
| CxxV | Column Code | C005: Column 5 |
| VxxV | SubColumn Code | |

The Document Identifier (such as RID0) will only contain one or the whole Document, in which the Document Identifier is stored in the first Section. The Document Identifier contains details such as creator details, document details, update history, attributes and etc. Furthermore, the eDoc String data structure is also an Nth-dimension data structure where another eDoc String can be encapsulated within the ü[ . . . ü] and stored in a Column. The LDSRC Codes is also representing the GIS of an eDoc String stored. To retrieve the eDoc String, the LDSRC Codes are used to locate them.

Example of eDoc String: (Store in LHR0)

```
üDHR1û
      ûS001û
ûRID0ûdxxvû1ûUûLHR0ûLD08003ûûûDHR1ûCûûûûûûûId1302
EûLeave Applicationû12/12/2013ûûûû,&-.~~~~ûüRû
üRNA5ûû1ûûûûûûûûûûûûûûploadûûûûûûNûrûl
AfizabintilbrahimûLot No. 4 LrgKingland 1, TmnKingland Phase
2, 88100 Petagas, KKûMalaysiaûNurulAfizabintilbrahimûDato
Sri MikeûSisterû016-8451196ûûIT
SUPPORTûFizaûûûûûûûûûû8ûSûPPORTûûûûûûûûûû1430996
7û830430-12-5720ûûû454 101 9729û61692683û830430-12-
5720û2000û2500û500ûûûûûûcobraangels@gmail.comûûûûûûû
ûûûûûûûû20Oct08û20Jan09û29/11/2013û28/11/2013ûûûûûûûûû
ûûûûûûûûûûûûûûûûûûûûûûûPETALING JAYAûûûûûûû014
3757463ûûûûûûûûûûûJûnior Server
AdministratorûûûûûûûFemaleûûokûokûokûRecommendedûûûû
OTHERSû4.0û12ûûûû11.0û09/12/2013û1ûûûCREATIVEûûûû0
0000036ûProject Loanûûûûû(,`,)~~~ûüRû
üR133ûû1ûûûûûûûûûûûûûûûûû2û2û2013ûûûD318ûALûûûûûûû‘
’,(~~~~ûüRû
üRRpD1ûû1ûûûûûûûûûûûûûûûûûûûûûûûûûûtesting approve
10.40ûûûûûûûûûûûûûûûûûûûûûûûûûûûûûûûûûûûûûûûûûûûûûû
ûûûûûûûû04/12/2013ûûûûûûûûûûûûûûûûûûûûûûûûûûûûûûûûûa
aaaaaaaûûûûûûûûûûûûûûûûûûûûûûûûûûû111ûûûûûûûûûûûûûû
ûûûûûûûûûûûûûûûûûûûûûû*&&-~~~~ûüRû
üR134ûD313û1ûûûûûû1640ûûûûûûûûûûûû1640û2014ûûûûPER
SONALLOANûû
      ü[
          üDHR1ûüS001ûüRID0ûdxxvû1ûûûLHR0ûLD0800
          3ûûûDHR1ûCûûûûûûûId1302EûLeave
          Applicationû12/12/2013ûûûû,&-.~~~~ûüRû
          üRR134ûD313û1ûûûûûû1640ûûûûûûûûûûûû1640
                    û2014ûûûûPERSONALLOANûûûûûûû(‘−
                    +~~~~ûüRûüSûüDû
                ü]
          ûûûûû(‘−+~~~~ûüRû
      üSû
üDû
```

eDict

As illustrated in FIG. 11, the Electronic Dictionary (eDict) or metadata is used to describe the attribute/behavior of each ledger (LxxV), document (DxxV) and Rowtype (RxxV). For LxxV level, the ledger identifier, eDoc updating methods (FIFO, LIFO, Update or Overwrite) and number of eDoc to be kept in eLedger is predefined in Ledger type eDict. For DxxV level, the document type to be or can be stored is predefined in the Document type eDict. For RxxV level, the Rowtype type eDict is categorized into 3 parts; first, general attributes such as name, data type, data length and so forth; second, display attributes such as font type, size, color and so forth; third, computation attributes like data validation and computation. The table 3.0, 4.0 and 5.0 shows an example of metadata or library predefined for Ledger, Document and Rowtype.

Ledger eDict—Definition

TABLE 3.0
Dictionary

| # | Name | Function | Length | Description |
|---|---|---|---|---|
| 1 | row | data | 4 | RDL0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Ledger (LXXV) |
| 7 | ac2 | data | 16 | |
| 8 | proj | data | 4 | Project |
| 9 | datatyp | data | 1 | |
| 10 | usg | data | 1 | |
| 11 | opt | data | 1 | |
| 12 | subfield | data | 4 | |
| 13 | nm1 | data | 32 | Ledger name |
| 14 | nm2 | data | 32 | Update method (FIFO/LIFO/U/O) |
| 15 | le | data | 2 | Max document |
| 16 | de | data | 1 | |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | res3 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Document eDict—Definition

TABLE 4.0
Dictionary

| # | Name | Function | Length | Description |
|---|---|---|---|---|
| 1 | row | data | 4 | RDD0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Doc (DXXV) |
| 7 | ac2 | data | 16 | |
| 8 | proj | data | 4 | Project |
| 9 | datatyp | data | 1 | File type (Excel/Email/bin/eDoc) |
| 10 | usg | data | 1 | |
| 11 | opt | data | 1 | |
| 12 | subfield | data | 4 | |
| 13 | nm1 | data | 32 | Document name |
| 14 | nm2 | data | 32 | |
| 15 | le | data | 2 | Size of Doc |
| 16 | de | data | 1 | Version |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | res3 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Rowtype eDict—Definition

TABLE 5.0
Dictionary

| # | Name | Function | Length | Description |
|---|---|---|---|---|
| 1 | row | data | 4 | RDC0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | RowCol (RxCx) |
| 7 | ac2 | data | 16 | |
| 8 | proj | data | 4 | Project |
| 9 | datatyp | data | 1 | Data (9/A/X/B/D/T) |
| 10 | usg | data | 1 | Usage (C/Blank) |
| 11 | opt | data | 1 | Optional |
| 12 | subfield | data | 4 | Subfield |
| 13 | nm1 | data | 32 | Label |
| 14 | nm2 | data | 32 | Name of column |
| 15 | le | data | 2 | Max Length |
| 16 | de | data | 1 | Decimal (2 dec) |
| 17 | def | data | 16 | Default |
| 18 | hid | data | 10 | HTML ID |
| 19 | htag | data | 4 | HTML Type |
| 20 | htype | display | 4 | # of elements |
| 21 | hstyle | display | 255 | Font, x, y, etc |
| 22 | lig | data | 255 | URL |
| 23 | dup | entry | 1 | Duplicate |
| 24 | msk | display | 200 | Mask |
| 25 | cond | compute | 255 | Condition |
| 26 | comp | compute | 255 | Computation |
| 27 | next | compute | 4 | Tab index |
| 28 | der | data | — | Derived Data |
| 29 | mnle | validate | 2 | Minimum length |
| 30 | mxv | validate | 14 | Maximum value |
| 31 | mnv | validate | | Minimum value |
| 32 | res1 | reserved | | |
| 33 | res2 | data | 4 | Section |
| 34 | res3 | reserved | | |
| 35 | res4 | reserved | | |
| 36 | res5 | reserved | | |
| 37 | bal | data | — | |
| 38 | size | data | — | Size of this row |
| 39 | secu | data | 8 | Security |
| 40 | cksum | data | 8 | Checksum |

Example of eDict Structure

üDDR0û
üS001û
<--------------------- 40 columns in horizontal representation ---------------
-------------->
üRDC0û doc û sq û st û lg û ac1 û ac2 û proj û datatyp û ûsg û opt û
subfield û nm1 û nm2 û le û de û def û hid û htag û htype û hstyle û lig
û dûp û msk û cond û comp û next û der û mnle û mxv û mnv û res1 û
res2 û res3 û res4 û res5 û bal û size û secûû cksûmüRû
üSû
üDû

eLedger

Electronic Ledger (eLedger) is where summaries or derivatives of eFile that is kept in variable length or fixed length format thus allowing for greater flexibility and fast retrieval. The Information in eLedger can be deleted and modified. Each eFile can have multiple eLedgers if required (for speedy reporting purposes). The update method of each eDoc to the eLedger is predefined in eLedger dictionary. The eLedger can contain n copies of eDoc that arrange in FIFO or LIFO manner; or new eDoc can override the exiting eDoc in the eLedger; or the update only manipulate data from certain column(s) in eDoc with the predefine column(s) in eLedger. The system may further include Zero Balancing function where every transaction can be traced and no information is ever deleted, which means everything will be balanced (always balance to last cent). All transactions have a copy in the Transaction Ledger, so changes to any account are immediately verifiable and problems isolated. The system also may make the system naturally SOX Compliant (Sarbanes-Oxley Act of 2002). The system may further include Reverse Processing where a new eLedger can be generated or regenerated from eFile based on new configuration or updated configuration.

As illustrated in FIG. 12, the eLedger contains example customer profile that includes customer details (RNA6—Name and Address Rowtype) and summary of total item such as apple, orange and pear bought daily (R320—32-day Rowtype) and monthly (R130—13-month Rowtype) for year 2014. The summary in the eLedger are populated from the daily transactions in eFile.

### Rowtype Header & Footer

TABLE 6.0

| sq | name | description |
|---|---|---|
| 1 | RxxV | rowtype |
| 2 | RWCD | row code |
| 3 | RWSQ | sequence |
| 4 | RWST | status |
| 5 | RWLG | ledger |
| 6 | RWA1 | account 1 |
| 7 | RWA2 | account 2 |
| 8 | RWCO | company & department |
| . . . | . . . | |
| n + 1 | RWBA | balance |
| n + 2 | RWSZ | size |
| n + 3 | RWSE | security |
| n + 4 | RWCS | checksum |

All Rowtype contains a Header with 8 columns and a Footer with 4 columns as shown on the Table 6 above. The row code (RWCD) of the Rowtype Header indicates its uniqueness among other same Rowtypes that appear within a Section and ledger (RWLG), account 1 (RWA1), account 2 (RWA2) and company & department (RWCO) indicates the location of the Rowtype in the database. The security (RWSE) of the Rowtype Footer is used to ensure that the right user(s) can access this row and the checksum (RWCS) is to ensures the data within the row is not corrupted.

### Subsequent Documents (SubDoc)

As illustrated in FIG. 13, the creation of Subsequent Documents (subDoc), where the system splits a Doc so that it can be debited/credited to relevant account, each subDoc is appended as a string one after another. The Main Doc and subDoc(s) will have the same document identifier. For example, an invoice with document identifier, D232 may have a subDoc to debit customer account and subDoc to credit Apple, Orange and Pear Stock. (Referring to the example in FIG. 2).

### Reserve and Commit

It's a process where a set of predefined requirements have to be adhered before any updating can take place. For example in an invoice, the requirements will be the customer must have sufficient credit to be debited from the account and there must be sufficient stock to be stocked out before the process is committed.

### Header+Index+Data

As illustrated in FIG. 14, the eFiles are stored in a RDBMS table, where the table comprises of Control, Index and Data. The Control section contains key and details about the Page. The Index is used to locate the location of each eDoc in a Page, where the Indexing are done in Horizontal manner to create sub-filing system within a filing system. The Data is where the eFile is stored.

Example of Index for Account 1, Relative Page is as below:

DHR0:20140828: 5: U: 0: 122/DHR0:20140828: 6: U: 122:

250/DHR0:20140828: 7: U: 250: 372/

Each account contains a eFile and the eFile contains number of eDocs. The eFile is chopped into Pages according to Page size before storing into RDBMS. The Page number begins from Relative Page and when a new Page is added, the Relative Page is advanced to Page 1 and the Page number of the newly added Page is 0 and so forth. Besides that, Relative Page is also a relative page to the system; the enquiry will always start from Relative Page.

The Control section may also include the following:
lg—ledger identifier
ac1—account 2
lpgn—last page no
ssq—start document sequence no
sln—start Page line no
esq—end document sequence no
eln—end Page line no
date—last updated date
st—the status of the eFile such as deleted
co—company and department
bal—balance of all eDocs

As illustrated in FIG. 15, the system will obtain a identifier of the requested eDoc based on input from user or a system (1001). Then, the system will search in virtual memory or local database for eDoc having the same identifier (1002). If the file was found, the system will retrieve the eDoc to at least one Output (1006). However, if the identified eDoc does not exist in virtual memory, the system will further proceed to search if eDoc key inside index, based on the index information (1004). Then, if eDoc key not exist in index (1005), the system will attempt to communicate with server to check if the connection to server is available and established (1007). If connection is not available (1008), prompt error to the users (1014). However, if connection is available, server will identify the request (1009) and proceed to fetch the requested eDoc from eFiling system (1010). Then, save eDoc in local virtual memory (1011) then transfer the eDoc to a local database (1011). Finally, update index with key and information (1013).

As illustrated in FIG. 16, the system will capture enquiry details based on users input or database (2001). Then, the system will send enquiry details to enquired eDoc (2002). Then, the program retrieving enquired documents (eDoc) that match enquiry details (2003). Then splits into single document and store them temporary database (2004). Thereafter, the system will retrieve key information from each document such as creator, date (2005). In which, the system will populate the documents into a list (2006). Based on the list of document, user can choose to view or edit column if there is one for any document (2007). If user chosen to view, disable all components and proceed to load the form (2009). However, if user chosen to edit, load the form and change action code to editable-mode (Code-M) (2008). Then, retrieve document from the temporary storage (2010). Thereafter, display the document (2011).

As illustrated in FIG. 17, the system will receive input based on ledger identifier and account 1 from a user or database (3001). Then, the system retrieves INDEX (indexes) and DATA from database based on the input received (3002). Then, the system will parse the retrieved Indexes into individual index (3003). Thereafter, the system will retrieve at least one eDoc (3007) based on the parsed index (3004) and perform validation for each of the individual index (3005). The the system will display the enquired eDoc (3006).

As illustrated in FIG. 18, the system receives the identified eDocument based on a Input from user or database that was retrieved. Thereafter, the system attempts to communicate with a server to save the Electronic Documents (eDoc) on the server database (4001). Then, the system establishes connection by verifying the connection to the server (4002). If connection to server is not available, save eDoc into temporary file or storage (4003). Then, update the index information of the new eDoc (4004) and hold the operation until connection to the server established (4005). However, If connection to the server is available, process and send all eDoc to server to process (4006). The server will then process and update eFiling system (4007).

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

1.-20. (canceled)

21. A system to emulate a manual filing system by storing and processing a document that operates on a relational database management system, comprising:
an electronic document having at least one electronic document identifier, section, rowtype or column;
a virtual memory for storing the electronic document; and
a web-read module for retrieving the electronic document from the virtual memory based on at least one identifier of the electronic document;
wherein the web-read module for retrieving the electronic document comprises:
a paging module having the electronic document appended into at least one electronic file in the relational database management system according to a predefined page limit;
an index module having at least one index for the electronic file based on document identifier, date, end sequence number, document status, document offset or document length; and
a read module to obtain the index and at least one data relative page of the electronic file from the index module based on the identifier, in which the electronic document is retrieved from the paging module based on the retrieved index and data relative page to be stored in the virtual memory and update the index module.

22. The system according to claim 21, wherein the identifier of the electronic document comprises the electronic document identifier, section, rowtype or column.

23. The system according to claim 21, wherein the identifier of the electronic document comprises the document identifier, date, end sequence number, document status, document offset or document length.

24. The system according to claim 21, further comprising:
an enquiry module for retrieving a plurality of electronic document information using a read module based on at least one information for the electronic document identifier, section, rowtype or column of the electronic document, in which the retrieved electronic document information has at least one file history display into at least one list form.

25. The system according to claim 21, further comprising:
a mapping module having a predetermined mapping instruction to identify and retrieve the electronic document.

26. The system according to claim 24, wherein the enquiry module further comprises:
an editing module to load the retrieved electronic document for updating the retrieved electronic document and store at least one updated data to the virtual memory.

27. The system according to claim 24, wherein the enquiry module further comprises:
a viewing module to load the retrieved electronic document for viewing the retrieved electronic document.

28. The system according to claim 24, wherein the enquiry module further comprises:
a searching module, wherein the searching module retrieves the electronic document using the web-read module based on at least one index, in which the index is retrieved from the identifier of the electronic document comprising document identifier, date, end sequence number, document status, document offset or document length.

29. The system according to claim 21, wherein the web-read module further comprises:
an uploading module to upload the electronic document based on the identifier of electronic document, in which the uploading module establishes a connection to at least one server having the relational database management system and update the relational database management system with the uploaded electronic document.

30. A method to emulate a manual filing system by storing and processing a document that operates on a relational database management system, comprising the steps of:
obtaining at least one identifier of an electronic document;
validating if there is at least one electronic document based on the identifier in at least one virtual memory using a web-read module; and
retrieving the validated electronic document from the virtual memory, if there is an electronic document in the virtual memory;
wherein validating if there is at least one electronic document based on the identifier in at least one virtual memory using a web-read module further comprises steps of:
obtaining at least one index and at least one data relative page of an electronic file having document identifier, date, end sequence number, document status, document offset or document length from an index module based on the identifier;
retrieving the electronic document from a paging module based on the index and data relative page in the relational database management system;
storing the electronic document in the virtual memory; and
updating the index module.

31. The method according to claim 30, wherein the identifier of the electronic document comprises the electronic document identifier, section, rowtype or column.

32. The method according to claim 30, wherein the identifier of the electronic document comprises the document identifier, date, end sequence number, document status, document offset or document length.

33. The method according to claim 30, further comprising the steps of:
identifying a plurality of electronic document information based on at least one information for the electronic document identifier, section, rowtype or column of the electronic document using a read module; and
retrieving the identified electronic document information using an enquiry module; and
displaying the retrieved electronic document information having at least one file history into at least one list form.

34. The method according to claim 30, further compromising:
a mapping module having a predetermined mapping instruction to identify and retrieve the electronic document.

35. The method according to claim 33, wherein the retrieving step further comprises the steps of:
loading the retrieved electronic document for updating the retrieved electronic document and store at least one updated data to the virtual memory using an editing module.

36. The method according to claim 33, wherein the retrieving step further comprises the steps of:
loading the retrieved electronic document for viewing the retrieved electronic document using a viewing module.

37. The method according to claim 33, wherein the retrieving step further comprises the steps of:
retrieving the electronic document using the web-read module based on at least one index, in which the index is retrieved from the identifier of the electronic document comprising document identifier, date, end sequence number, document status, document offset or document length using a searching module.

38. The method according to claim 30, further comprising steps of;
uploading the electronic document based the identifier of the electronic document from the virtual memory;
establishing a connection to at least one server having the relational database management system and
updating the relational database management system with the uploaded electronic document.
